(19) United States
(12) Patent Application Publication
(10) Pub. No.: US 2024/0170234 A1
(43) Pub. Date: May 23, 2024

(54) WASTE DISPOSER SYSTEM INCLUDING INTEGRATED AIR SWITCH

(71) Applicant: InSinkErator, LLC, Mount Pleasant, WI (US)

(72) Inventors: Jeffrey S. Ward, Kenosha, WI (US); Walter A. Bennage, Pleasant Prairie, WI (US); Kelly T. Gamble, Waterford, WI (US)

(21) Appl. No.: 17/989,839

(22) Filed: Nov. 18, 2022

(51) Int. Cl. H01H 3/22; H01H 9/02

(52) U.S. Cl. CPC H01H 3/22; H01H 9/02; E03C 1/2665

(57) ABSTRACT

Waste disposer systems such as food waste disposer systems in which waste disposers such as food waste disposers are integrated with air switch assemblies, and related methods, are disclosed herein. In an example embodiment, a food waste disposer system includes a housing, a power control module, a motor, an actuator, an air conduction tube connecting the actuator at least indirectly with the module, and a power link. The module is configured to switch between having a first status and having a second status in response to a pressure change communicated through the tube as a result of an actuation of the actuator. Further, electric power received at the power link is communicated to the motor from the power link at least indirectly via the module when the module has the first status, but is not communicated to the motor when the module has the second status.

### FIELD

The present disclosure relates to waste disposers such as food waste disposers and, more particularly, to control systems for use in or in conjunction with such waste disposers or associated devices, as well as to waste disposers comprising such control systems, and to methods of assembling and/or operating control systems in relation to waste disposers or associated devices.

### BACKGROUND

Food waste disposers are used to comminute food scraps into particles small enough to pass through household drain plumbing. Such food waste disposers can be powered in several manners depending upon the embodiment or environment. Most older homes (pre-1970's) have a Romex/BX cable extending from a wall of the home, which can be coupled and terminated directly to the disposer in a hardwired manner. However, most newer homes have a standard electric power outlet (e.g., a wall outlet) near the disposer, to which the disposer can be coupled by way of a power cord and associated plug so as to receive power. Out of all homes, it is estimated that 60% of homes with a disposer have hardwiring and that the remaining 40% use a power outlet located in the sink cabinet.

In many installations of food waste disposers, whether power is provided to the disposer (or whether the disposer is switched on or off) can be determined by way of a built-in wall switch. Such installations can include ones in which the disposers are installed via hardwiring including a Romex/BX cable as well as ones in which the disposers are coupled to an electrical power outlet by way of a power cord and associated plug. In such installations, whether power is made available to the food waste disposer, via the Romex/BX cable or via the electrical power outlet and power cord and plug as the case may be, is determined based upon the status of the wall switch.

However, in other installations, whether power is provided to the disposer (or whether the disposer is switched on or off) is determined by way of an additional operator-controllable switching mechanism other than (or in addition to) a built-in wall switch. In some such embodiments, a food waste disposer is implemented in conjunction with an aftermarket air switch power control device by which an operator can control the provision of power to the disposer (or whether the disposer is switched on or off). The air switch power control device includes a power control module linked to an operator-actuatable push button by way of an air conduction tube. The power control module has an electrical power outlet into which the plug of a power cord of the disposer can be plugged. Further, the air switch power control device also includes a power cord extending between the power control module and an associated plug, which can be plugged into another electrical power outlet such as a wall outlet.

Such an air switch power control device is configured to have two operational states. In a first one of the operational states, the electric power received via the power cord of the air switch power control device, which is coupled to the wall outlet, is in turn communicated to the electrical power outlet of the power control module itself. In this first operational state, any food waste disposer coupled to the electrical power outlet of the power control module (e.g., coupled by way of a power cord of the disposer itself) can receive electric power and be switched on. Also, in a second one of the operational states, the electrical power outlet of the power control module is decoupled electrically from the power cord of the air switch power control device. In this second operational state, no power from the wall outlet is provided at the electrical power outlet of the power control module, and thus any food waste disposer coupled to the electrical power outlet of the power control module cannot receive power and is switched off.

Whether the air switch power control device is in the first operational state or in the second operational state depends upon operator actuation of the operator-actuatable push button. More particularly, upon being pressed by an operator, the operator-actuatable push button causes air to be forced away from the push button through the air conduction tube to a diaphragm in the power control module, which moves in response to change in air pressure (or the received air flow). The position of the diaphragm in turn controls the state of an electric switch that governs whether electric power received at the power control module from the wall outlet is provided to the electrical power outlet of the power control module and thus provided to power any disposer coupled to that electrical power outlet. For example, if the push button is depressed and causes air flow to proceed toward the diaphragm, then in turn movement of the diaphragm can occur that causes the electrical switch to be closed and results in electric power being communicated to the disposer. Further, if the push button is released such that air flow moves toward the push button, then in turn corresponding movement of the diaphragm can occur that causes the electrical switch to be open-circuited and results in the disposer no longer receiving electric power.

Although such an air switch power control device enables an operator to control the provision of power from a wall outlet to a food waste disposer coupled to that air switch power control device without the presence of a wall switch, there are several disadvantages associated with installations involving such an air switch power control device. In particular, implementation of such an air switch power control device can be unwieldy or awkward given the number of connections/linkages involved, including not only the power cord of the food waste disposer itself but also the power cord of the air switch power control device, in addition to the air conduction tube, and also insofar as it may be difficult to find a location (e.g., under a kitchen sink) at which the power control module can be situated/supported in a manner that accommodates these connections/linkages.

For at least one or more of these reasons, or one or more other reasons, it would therefore be advantageous if improved control mechanisms or systems for use in or in conjunction with food waste disposers or other disposers and/or associated devices could be developed, and/or if improved food waste disposers or other disposers having or operating in conjunction with such improved control mechanisms or systems could be developed, and/or if improved methods of assembling and/or operating such mechanisms, systems, or disposers could be developed, so as to address any one or more of the concerns discussed above or to address one or more other concerns or provide one or more benefits.

### BRIEF SUMMARY

In at least one example embodiment, the present disclosure relates to a food waste disposer system. The food waste disposer system includes a housing including a bottom housing portion and a top housing portion, and a power control module supported at least partly within the housing. Also, the food waste disposer system includes a motor supported within the housing and coupled electrically, at least indirectly, to the power control module. Further, the food waste disposer system includes an actuator positioned externally of the housing, and an air conduction tube connecting the actuator at least indirectly with the power control module. Additionally, the food waste disposer system includes a power link extending outward from the power control module and the housing, so that the power control module can be coupled electrically, at least indirectly, to a power source. The power control module is configured to switch between having a first operational status and having a second operational status in response to a pressure change communicated through the air conduction tube as a result of an actuation of the actuator. Further, electric power received at the power link from the power source is communicated to the motor from the power link at least indirectly via the power control module when the power control module has the first operational status, but is not communicated to the motor when the power control module has the second operational status.

Additionally, in at least one example embodiment, the present disclosure relates to a method. The method includes providing a waste disposer system including a housing including a bottom housing portion and a top housing portion, a power control module supported at least partly within the housing, a motor supported within the housing and coupled electrically, at least indirectly, to the power control module, an actuator positioned externally of the housing, an air conduction tube connecting the actuator at least indirectly with the power control module, and a power link extending outward from the power control module and the housing, so that the power control module can be coupled electrically, at least indirectly, to a power source. Further, the method includes receiving electric power at the power control module at least indirectly via the power link, and transmitting a pressure change through the air conduction tube to the power control module in response to an actuation of the actuator. Additionally, the method includes switching from a first operational status of the power control module to a second operational status of the power control module in response to the pressure change, and communicating the electric power received via the power link to the motor from the power link at least indirectly via the power control module when the power control module has the first operational status. Further, the method includes additionally switching from the second operational status to the first operational status in response to an additional pressure change, and ceasing the communicating of the electric power to the motor when the power control module has the second operational status.

Further, in at least one example embodiment, the present disclosure relates to an air switch assembly for implementation in combination with a waste disposer in an integrated manner so as to provide air switch control of operation of the waste disposer. The air switch assembly includes a power control module including a base plate and also a switching mechanism and a terminal assembly that are each supported upon the base plate, where the base plate includes at least one feature that enables, at least in part, the base plate to be secured to the waste disposer. Additionally, the air switch assembly includes a power link extending outward from the power control module, where the power link includes a plug at an end apart from the power control module that is configured for being coupled to a wall outlet. Further, the air switch assembly includes an air switch mechanism including an actuator and an air conduction tube linking the actuator with the power control module, where the switching mechanism includes a diaphragm structure at least indirectly in communication with an electrical switch. Also, the diaphragm structure is configured to be moved in response to pressure changes communicated via the air conduction tube in response to actuations of the actuator, and the switching mechanism is configured so that the electrical switch changes switch states in response to movements of the diaphragm structure. Further, the terminal assembly includes a plurality of first electrical contacts that are configured to engage a plurality of second electrical contacts formed along an interior of the waste disposer, so as to allow for a direct physical connection and a direct electrical connection to be formed between the power control module and the plurality of second electrical contacts.

### BRIEF DESCRIPTION OF THE DRAWINGS

Embodiments of waste disposer systems (e.g., food waste disposer systems), waste disposers (e.g., food waste disposers), control systems for integration or implementation in combination with such disposer systems or disposers, combination systems including associated or auxiliary devices in addition to such disposer systems or disposers, and/or related methods, are disclosed with reference to the accompanying drawings and are for illustrative purposes only. The systems and methods encompassed herein are not limited in their applications to the details of construction, arrangements of components, or other aspects or features illustrated in the drawings, but rather such systems and methods encompassed herein include other embodiments or are capable of being practiced or carried out in other various ways. Like reference numerals are used to indicate like components. In the drawings:

FIG. 1 is a top, substantially front perspective view of a first example food waste disposer system having a first example food waste disposer and an integrated air switch arrangement, and shown to be mounted in relation to a sink;

FIG. 2 is a schematic view illustrating electrical and pneumatic components of the food waste disposer system of FIG. 1, and how those components are coupled with one another in that food waste disposer system;

FIG. 3 is a bottom perspective cutaway view of a food waste disposer of the first example food waste disposer system of FIG. 1, shown independent of the sink and without the integrated air switch arrangement of FIG. 1;

FIGS. 4 and 5 are first and second top perspective views of portions of the air switch assembly of the food waste disposer system of FIG. 1; and

FIGS. 6 and 7 are bottom perspective cutaway views of portions of the food waste disposer system of FIG. 1, including portions of the air switch assembly of FIG. 1, illustrating how the air switch assembly can be implemented in relation to the food waste disposer.

### DETAILED DESCRIPTION

The present disclosure relates to waste disposer systems such as food waste disposer systems, and more particularly to such waste disposer systems having control systems included therewithin or integrated or utilized in conjunction with waste disposers thereof, as well as to such control systems for use in conjunction with or as part of such waste disposer systems, and also to methods of operating and implementing such waste disposer systems and waste disposers and control systems thereof.

More particularly in this regard, the present inventors have recognized that an improved food waste disposer system in at least some embodiments will include an air switch power control device or arrangement (or simply air switch assembly) that is integrated with a food waste disposer of the food waste disposer system, where such integration particularly involves positioning a power control module of the air switch arrangement within (or as part of) the food waste disposer of the food waste disposer system. Given such an arrangement, control over whether power is provided to the food waste disposer, or whether the food waste disposer is actuated, can be governed by actuation of an air switch actuator (e.g., button) that is coupled to the power control module within the food waste disposer by an air conduction tube. By employing such an arrangement, control over the food waste disposer as governed by actuation of the air switch actuator can be achieved without any additional power links or cords being employed externally of the food waste disposer to couple the power control module to the food waste disposer.

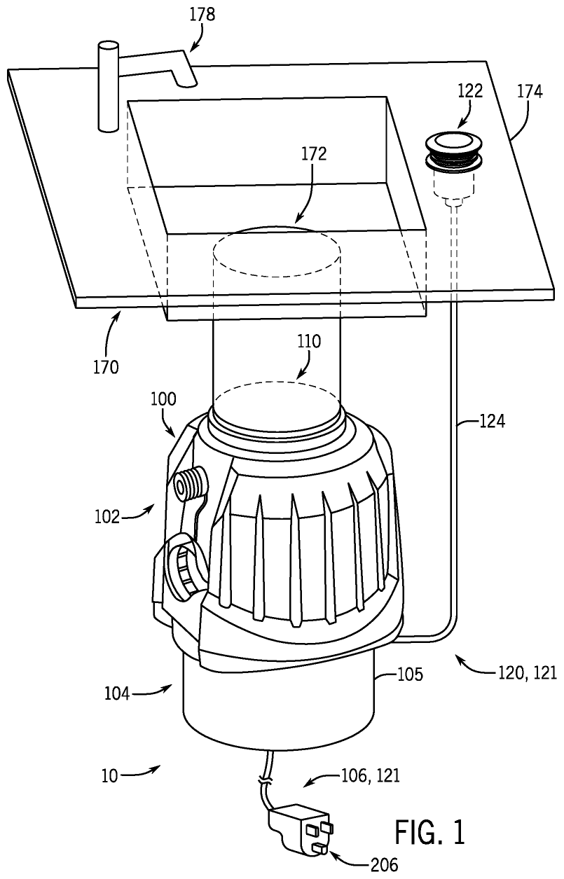

Referring to FIG. 1, a top, substantially front perspective view of a food waste disposer system or assembly 10 is shown, in accordance with a first example embodiment encompassed herein. As illustrated, the food waste disposer system 10 includes a food waste disposer 100 having a top housing portion (or enclosure) 102 and a bottom housing portion 104. The bottom housing portion 104 includes a cylindrical stator band 105 and a lower end frame (LEF) 306 (see FIG. 3), where the LEF serves as the disk-shaped bottom surface of the food waste disposer. In general, the food waste disposer 100 can be understood as including a food conveying section, a motor section, and a grinding section. The food conveying section is generally positioned at a location corresponding to the location of the enclosure 102, at or near the top of the food waste disposer 100. The motor section is generally positioned at a location corresponding to and within the stator band 105, at or near the bottom of the food waste disposer 100. The grinding section is disposed between the food conveying section and the motor section.

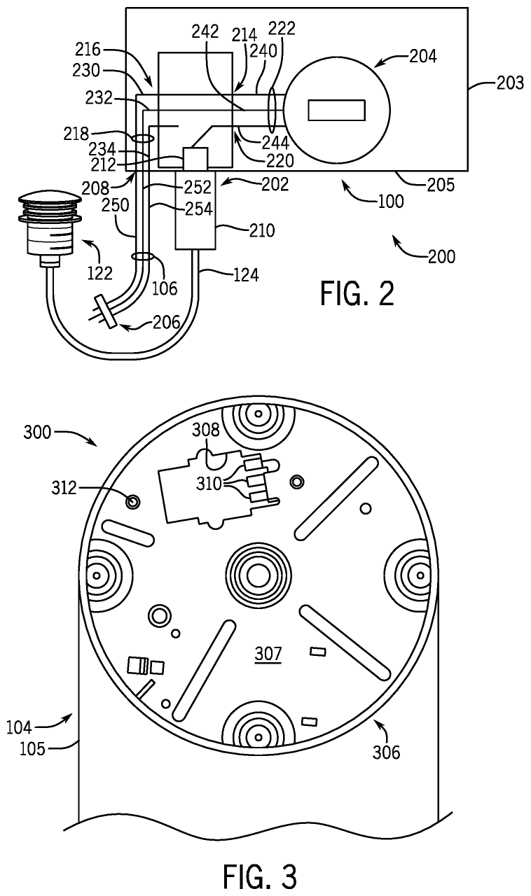

The motor section includes a motor 204 (see FIG. 2) imparting rotational movement to a motor shaft to operate the grinding section. In the present example embodiment, the motor can be an electric motor that is an inductive motor, although the present disclosure is intended to encompass embodiments of food waste disposers employing other types of motors such as permanent magnet motors. Power for operating the motor within the motor section in the present embodiment is communicated to the food waste disposer 100 from an external power source by way of a pluggable power cord or power link 106 including a NEMA 5-15 plug (or wall plug) 206 that can be plugged into a wall outlet (not shown), as discussed further below.

As further shown in FIG. 1, the food waste disposer system 10 also includes, in addition to the food waste disposer 100, an air switch mechanism or arrangement 120. In the present embodiment, the air switch mechanism 120 is integrated with the power link (pluggable power cord) 106, and the air switch mechanism 120 in combination with the power link 106 can be referred to simply as an air switch assembly (or, alternatively, an air switch power control device or arrangement, or an integrated plug assembly) 121. As described in further detail below, the air switch assembly 121 is coupled to the food waste disposer 100, such that the food waste disposer system 10 can be considered an integrated or combination system that includes both the food waste disposer 100 and the air switch assembly (or integrated plug assembly) 121 (including both the air switch mechanism 120 and the power link 106). Indeed, the food waste disposer system 10 can be considered a food waste disposer system in which the air switch assembly (or integrated plug assembly) 121 is integrated with the food waste disposer 100.

Additionally as shown in FIG. 1, the food waste disposer system 10, and particularly each of the food waste disposer 100 and air switch mechanism 120 of that food waste disposer system 10, are mounted or supported in relation to a sink 170 having a faucet or tap 178. More particularly, the food waste disposer 100 is coupled to a drain at the bottom of a basin 172 of the sink 170. It should be appreciated that the food conveying section of the food waste disposer 100 particularly includes an inlet 110 that is coupled to the drain for receiving food waste and fluid (e.g., water), and conveys the food waste to the grinding section of the food waste disposer. Further, the air switch mechanism 120 also includes an air switch actuator 122 that is supported on an upper surface 174 of the sink 170 and an air conduction tube (or air hose) 124 that links the actuator 122 to a power control module 202 (see FIG. 2) that is supported along the LEF 306 (see FIG. 3) of the food waste disposer 100 (a portion of the air conduction tube that is positioned beneath the sink 170 is shown in phantom). Although the actuator 122 can take a variety of forms depending upon the embodiment, in the present embodiment the actuator can include a pneumatic cylinder arrangement including a bladder with a diaphragm such that, when the actuator is pressed, this causes air flow to proceed from the actuator through the air conduction tube 124 toward or to the power control module 202.

It should be understood that the sink 170, even though coupled to the food waste disposer system 10, is distinct from and not part of the food waste disposer system in the present embodiment. Also, although in the present description the air switch assembly 121 including the air switch mechanism 120 and power link 106 is considered to be distinct from the food waste disposer 100, in other embodiments or contexts one or more of the air switch assembly 121, the air switch mechanism 120, and the power link 106 can be considered to form a part of the food waste disposer 100 itself.

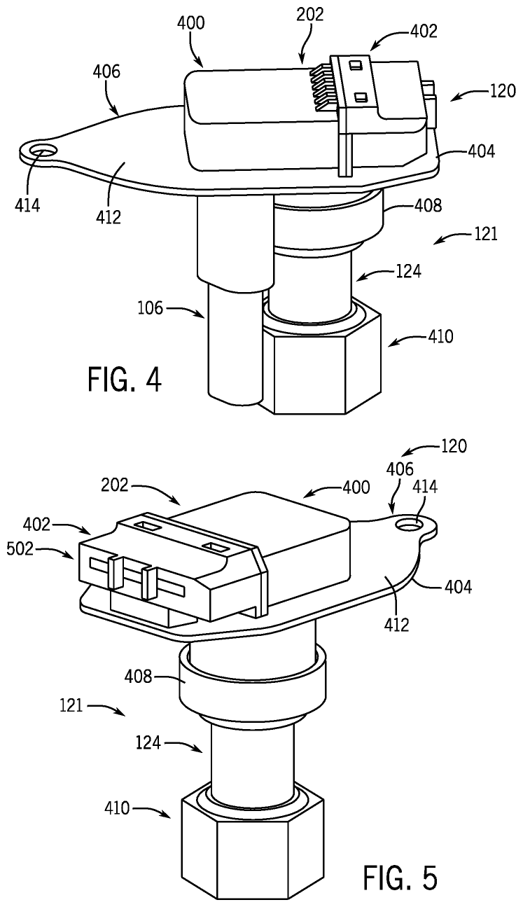

Turning to FIG. 2, a schematic diagram 200 is provided to further illustrate electrical and pneumatic components, and connections among those components, within the food waste disposer system 10 of FIG. 1, including both the food waste disposer 100 and also the air switch assembly 121 having the air switch mechanism 120 and the power link 106. The schematic diagram 200 shows that the food waste disposer system 10 includes the power control module 202 that is coupled to each of the actuator 122, the motor 204, and a power terminal 208. The power control module 202, along with the actuator 122 and the air conduction tube 124, is formed as part of the air switch mechanism 120 of the air switch assembly 121. The power control module 202 particularly can be mounted with respect to the food waste disposer 100 along the housing of the food waste disposer, which is represented in FIG. 2 by a rectangle 203, and particularly along the LEF 306 of the bottom housing portion 104, which is represented by a bottom edge 205 of the rectangle 203. The manner in which the power control module 202 is mounted in relation to the food waste disposer 100 is further described below in regard to FIGS. 4, 5, 6, and 7.

Further as illustrated, the power control module 202 particularly includes a diaphragm structure (or simply diaphragm) 210 that serves as an air pressure (or vacuum, or air flow) sensor, and that is coupled to the actuator 122 by the air conduction tube 124. Also, the power control module 202 includes a switch actuator 212 and a single throw switch 214. As shown, the diaphragm structure 210 is connected or coupled, within the power control module 202 as represented figuratively by the switch actuator 212, to the single throw switch 214. An input terminal 216 of the single throw switch 214 is coupled by a first electrical connector 218 to the power terminal 208. The first electrical connector 218 in the present embodiment includes three wires or connections, namely, a neutral wire 230, a ground wire 232, and a live (or hot) wire 234. Each of the power terminal 208 and the first electrical connector 218 can be considered to be parts of the power control module.

Additionally, a first output terminal 220 of the single throw switch 214 is coupled by a second electrical connector 222 to the motor 204. For purposes of the present description, the motor 204 and the second electrical connector 222 can be considered to be parts of the food waste disposer 100 rather than parts of the power control module 202, air switch mechanism 120, or air switch assembly 121. As with the first electrical connector 218, the second electrical connector 222 also includes three wires or connections, namely, a neutral wire 240, a ground wire 242, and a live (or hot) wire 244. The single throw switch 214 is coupled between the first electrical connector 218 and the second electrical connector 222 such that the neutral wire 230 is directly coupled to the neutral wire 240, the ground wire 232 is directly coupled to the ground wire 242, and the live wire 234 can be coupled directly to or decoupled from the live wire 244 based upon the open or closed status of the single throw switch 214, as governed by the switch actuator 212 in response to movement of the diaphragm structure 210.

In the present embodiment, the power terminal 208 is an internal node associated with the power control module 202 (relatedly, the first electrical connector 218 also can be considered to be a part of the power control module). As already noted in regard to FIG. 1, in the present embodiment, the power link 106 is a pluggable power cord (e.g., alternating current (AC) pluggable power cord) that is considered to be a part of the air switch assembly 121 of the food waste disposer system 10 and that particularly includes the plug 206 by which the power cord can be plugged into a wall outlet of the home or other installation environment within which the food waste disposer system 10 is being implemented. Also in the present embodiment, the power link 106 again includes three wires or connections, namely, a neutral wire 250, a ground wire 252, and a live (or hot) wire 254 that are respectively coupled at (or within) the power terminal 208 to the neutral wire 230, ground wire 232, and live wire 234 of the first electrical connector 218. Depending upon the embodiment, the power terminal 208 may be, but need not be, an additional physical junction including one or more electrical contacts (e.g., as formed by a socket) that is configured to be coupled to and in electrical communication with one or more other electrical contacts provided at the end of the power link 106 that is opposite the end at which the plug 206 is located.

In the present embodiment, the status of the single throw switch 214 is governed by the diaphragm structure 210, due to at least indirect physical contact between the diaphragm structure and the single throw switch as represented by the switch actuator 212. By virtue of the switch actuator 212, movement of the diaphragm structure 210 causes switching of the single throw switch 214 (thus, the switch actuator 212 can also be considered an actuation linkage between the diaphragm structure 210 and the single throw switch 214). The arrangement of the diaphragm structure 210 and single throw switch 214 can take the form, for example, of the pneumatic activated switch described in U.S. Pat. No. 6,418,870 issued on Jun. 25, 2002 and titled “Pneumatic Activated Switch,” the contents of which are hereby incorporated by reference herein.

When the diaphragm structure 210 experiences a sufficient increase in air pressure (or vacuum pressure, or in air flow), which can occur when air flows through the air conduction tube 124 toward the diaphragm structure due to actuation (e.g., depressing) of the actuator 122, the diaphragm structure by way of the switch actuator 212 impacts the single throw switch 214 in a manner causing the switch to change from being in a first operational state (or operating in a first operational mode) to being in a second operational state (or operating in a second operational mode). This can also be considered a first operational status of the power control module 202. Alternatively, when the diaphragm structure 210 experiences a sufficient decrease in air pressure (or vacuum pressure, or in air flow), which can occur when air flows through the air conduction tube 124 away from the diaphragm structure due to releasing of the actuator 122, the diaphragm structure impacts the single throw switch 214 in a manner causing the switch to change from being in the second operational state (or operating in the second operational mode) to being in the first operational state (or operating in the first operational mode). This can also be considered a second operational status of the power control module 202.

Additionally, in the present example embodiment, the first operational state of the single throw switch 214 can be a closed state. Accordingly, when the single throw switch 214 is in the first operational state, input power received at the input terminal 216 from the power terminal 208 (assuming that the power terminal 208 is coupled to an external power source) is communicated through the single throw switch to the first output terminal 220 and further to the motor 204 by the second electrical connector 222. Thus, in the present embodiment, the first operational state of the single throw switch 214 (and first operational status of the power control module 202) results in or corresponds to actuation of the motor 204. Alternatively, the second operational state of the single throw switch 214 can be an open state. Accordingly, when the single throw switch 214 is in the second operational state, input power received at the input terminal 216 from the power terminal 208 (assuming that the power terminal 208 is coupled to an external power source) is precluded from being communicated through the single throw switch to the first output terminal 220 or to the motor 204. Thus, in the present embodiment, the second operational state of the single throw switch 214 (and second operational status of the power control module 202) results in or corresponds to deactivation of the motor 204.

In at least one embodiment, the single throw switch 214 can be a normally-open switch that is biased (e.g., by a spring) to be in the second operational state. However, in other embodiments, the single throw switch 214 can be a normally-closed switch (e.g., biased by a spring to be in the first operational state) or need not be biased in any manner. Further, notwithstanding the above description of how the power control module 202 can operate in response to actuation signals communicated from the actuator 122 via the air conduction tube 124, the power control module 202 in other embodiments can be configured to operate in other manners. For example, in one additional embodiment, a toggle switch can be substituted for the single throw switch 214.

Referring additionally to FIG. 3, a bottom perspective cutaway view of a bottom section 300 of the food waste disposer 100 of the food waste disposer system 10 is further provided. The bottom section 300 shown in FIG. 3 particularly includes the bottom housing portion 104, including part of the cylindrical stator band 105 and the LEF 306, in a manner that is independent of the sink 170 and also independent of the air switch assembly 121, including the air switch mechanism 120 and power link 106 thereof. Given the absence of the air switch assembly 121, an orifice 308 provided along a bottom exterior surface 307 of the LEF 306 particularly is visible. Further, three electrical contacts 310 positioned within the interior of the food waste disposer 100 (that is, above the LEF 306 when positioned in a normal manner at the bottom of the food waste disposer) are also visible through the orifice 308. It should be appreciated that the three electrical contacts 310 are coupled (at least indirectly) to the motor 204 within the food waste disposer 100, and can be considered to constitute at least a portion of the second electrical connector 222. Therefore, as will be described further below in regard to FIGS. 4, 5, 6, and 7, when the air switch assembly 121 is assembled in relation to the food waste disposer 100, the air switch assembly particularly is electrically coupled to the three electrical contacts 310 to allow for power to be provided to the motor 204.

Turning next to FIGS. 4 and 5, first and second top perspective cutaway views are provided of the air switch assembly 121. As shown, the air switch assembly 121 in the present embodiment includes the power link 106 and the air switch mechanism 120 including the power control module 202, which includes a switching mechanism 400 and a terminal assembly 402. As discussed above with respect to FIG. 2, the power control module 202 additionally includes the diaphragm structure 210 and the single throw switch 214, which are coupled with one another by the switch actuator (or actuator linkage) 212, as well as the power terminal 208 coupled to the single throw switch by the first electrical connector 218. With reference to FIGS. 4 and 5, the switching mechanism 400 of the power control module 202 can be particularly understood to include the single throw switch 214 and the switch actuator 212, as well as the power terminal 208 and the first electrical connector 218.

The terminal assembly 402 corresponds to the first output terminal 220 shown in FIG. 2 and includes, particularly as shown in FIG. 5, three electrical sockets 502. The three electrical sockets 502 have electrical contacts therewithin and are configured to respectively receive the three electrical contacts 310 when the air switch assembly 121 is coupled to (mounted in regard to) the food waste disposer 100, so as to allow for electrical coupling between the electrical contacts 310 and the electrical contacts within the electrical sockets 502. Accordingly, with such electrical coupling between the electrical contacts 310 and the electrical contacts within the electrical sockets 502, the power control module 202 can be coupled to the motor 204 within the interior of the food waste disposer (in this regard, the electrical contacts 310 can be considered to be, or correspond to, at least in part, the second electrical connector 222 of FIG. 2).

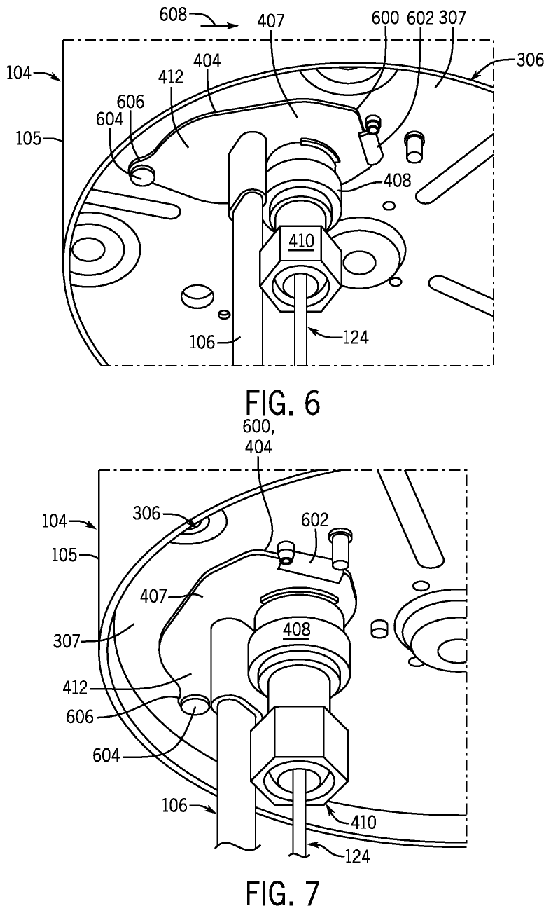

FIGS. 4 and 5 further show that, in the present embodiment, the power control module 202 also includes a base plate 404 having a first side 406 upon which each of the switching mechanism 400 and the terminal assembly 402 are supported. Further, FIG. 4 does show a portion of the power link 106, and FIGS. 4 and 5 do each show a portion of the air conduction tube 124. As illustrated, each of the power link 106 and the air conduction tube 124 approach the power control module 202 at a second side 407 (see FIGS. 6 and 7) of the base plate 404 opposite the first side 406. It should be appreciated that the power link 106 particularly can pass from the second side 407 to the switching mechanism 400 (e.g., to the power terminal 208 thereof) along the first side 406 via a corresponding port or hole (not shown) within the base plate 404. Further, in the present embodiment, a tube adapter 408 is provided along the second side 407 of the base plate 404 that receives the air conduction tube 124 and secures the air conduction tube to the base plate 404. In the present embodiment, the diaphragm structure 210 of the power control module 202 is positioned within the tube adapter 408. Given this arrangement, the switching mechanism 400 and the diaphragm structure 210 are positioned on opposite sides of the base plate 404, and are in communication with one another by way of at least one additional port or hole (not shown) within the base plate 404 so that the diaphragm structure is at least indirectly in communication with the single throw switch 214 by way of the switch actuator 212.

FIGS. 4 and 5 particularly are cutaway views insofar as most of the power link 106 of the air switch assembly 121 is not shown, and also insofar as the actuator 122 and most of the air conduction tube 124 of the air switch mechanism 120 also are not shown. In addition to the air conduction tube 124 being securely connected to the diaphragm structure 210 of the power control module 202 by the tube adapter 408 (in which is provided the diaphragm structure 210, as discussed above), the air conduction tube also is protected by way of a protective surrounding structure 410 (which in this example is at least partly hexagonally-shaped) at or proximate to where the air conduction tube is coupled to the power control module 202. As discussed further in regard to FIGS. 6 and 7, the base plate 404 in the present embodiment particularly includes an end extension 412 within which is formed a retaining screw hole 414.

Referring further to FIGS. 6 and 7, additional first and second bottom perspective cutaway views of portions of the food waste disposer system 10 are provided to illustrate how, in the present embodiment, the air switch assembly 121 is implemented in relation to the food waste disposer 100. As shown, when the air switch assembly 121 is fully installed relative to the food waste disposer 100, the base plate 404 is positioned against the bottom exterior surface 307 of the LEF 306, with the first side 406 of the base plate facing inwardly through the orifice 308 toward the interior of the food waste disposer 100 and the second side 407 of the base plate facing away from the LEF and away from the food waste disposer. Given this arrangement, the switching mechanism 400 and the terminal assembly 402 (not shown) are positioned so as to extend through the orifice 308 into the interior of the food waste disposer 100. Also, the power link 106 extends away from the switching mechanism 400 of the power control module 202, through the base plate 404, and away from each of the second side 407 of the base plate 404, the LEF 306, and the food waste disposer 100. Further, the air conduction tube 124 extends away from the diaphragm structure 210 of the power control module 202, away from each of the tube adapter 408 within which the diaphragm structure is positioned, the second side 407 of the base plate 404, the LEF 306, and the food waste disposer 100.

In the present embodiment, during installation, the power control module 202 is aligned relative to the orifice 308. Then the power control module can be moved toward and at least partly into the orifice, so that the switching mechanism 400 and terminal assembly 402 are inserted through the orifice and at least partly into an interior of the food waste disposer, and so that the base plate 404 comes into contact with the LEF 306. Next, the base plate 404 of the air switch assembly 121 is slid relative to the LEF 306 in a direction corresponding to an arrow 608 shown in FIG. 6, so that the three electrical contacts 310 fit into the three electrical sockets 502 of the terminal assembly 402 (as shown in FIGS. 3, 4, and 5). When this occurs, a first end edge portion 600 of the base plate 404 slides into a retaining lip 602 of the LEF 306. Then, additionally, a retaining screw 604 is inserted through the retaining screw hole 414 at the end extension 412 of the base plate 404, proximate a second end edge portion 606 of the base plate at the opposite end of the base plate relative to the first end edge portion 600. The retaining screw 604 additionally fits within an additional screw hole 312 (see FIG. 3) within the LEF. By virtue of being inserted/screwed through the retaining screw hole 414 and the additional screw hole 312, the retaining screw 604 couples the base plate 404 to the LEF 306.

Further, the retaining screw 604 precludes the base plate 404 from sliding relative to the LEF 306 in a manner that the first end edge portion 600 passes out from the retaining lip 602 (e.g., in a direction opposite the direction indicated by the arrow 608 of FIG. 6). Therefore, by virtue of the retaining screw 604 in addition to the retaining lip 602, the base plate 404 and thus the air switch assembly 121 overall is coupled to the LEF 306 and to the food waste disposer 100. Accordingly, it also will be appreciated that removal of the air switch assembly 121 from the food waste disposer 100, at a time when the air switch assembly is coupled to the food waste disposer, can be achieved by removing the retaining screw 604 and then sliding the base plate 404 along the LEF 306 so that the first end edge portion 600 passes out from the retaining lip 602 (again, in a direction contrary to the direction indicated by the arrow 608 of FIG. 6). When this occurs, the three electrical contacts 310 are disengaged from the three electrical sockets 502 of the terminal assembly 402, and then the air switch assembly 121 can be entirely disassembled from, and removed from, the food waste disposer 100.

The present disclosure is also intended to encompass further embodiments and modified versions of the above-described embodiments in addition to the embodiments specifically described above. Among other things, although the above description relates to food waste disposers, the present disclosure is also intended to encompass embodiments relating to other types of waste disposers. Also, notwithstanding the description above, the present disclosure is intended to encompass any of a variety of other types of arrangements by which a food waste disposer of a food waste disposer system (or a waste disposer of another type of waste disposer system) is coupled to an external power source to receive electric power. Also, the present disclosure is intended to encompass any of a variety of different types of food waste disposers or other waste disposers employing any of a variety of types of motors, for example, including permanent magnet motors in addition to induction motors.

Further, the present disclosure is intended to encompass any of a variety of types of terminals, sockets, plugs, connectors, fasteners, and other features allowing for various components, structures, and devices to be coupled or in communication with one another, either electrically or pneumatically. For example, depending upon the embodiment, any of a variety of wire joiner connectors, standard wire nuts, or other connectors can be employed to join various conductors or structures. Any one or more of such components can be considered, in at least some embodiments, to form part of a terminal or power terminal such as the power terminal 208. Also, the present disclosure is intended to encompass other types of fasteners instead of or in addition to the fastening devices described herein such as the retaining screw 604. Additionally for example, although the orifice 308 into which is positioned the air switch assembly 121 is shown to be positioned on the LEF 306 in FIG. 3, in other embodiments such an orifice (and additional structures nearby such as the electrical contacts 310 can be situated along any of a variety of other housing surfaces of a food waste disposer, such as along the stator band (e.g., along the stator band 105 in FIG. 1).

Also, although the present disclosure envisions embodiments in which a food waste disposer assembly is coupled to a wall outlet by way of a power cord having a plug such as a NEMA 5-15 plug, the present disclosure is also intended to encompass other embodiments that include or operate in conjunction with other types of connectors, plugs, and adapters, including for example C-13 or C14 sockets or plugs. Further, the present disclosure also includes a variety of different manners of operation and control as determined by a power control module such as (but not limited to) the power control module 202, at least in part as determined by an air switch mechanism such as the air switch mechanism 120.

Additionally, the present disclosure is intended to encompass other types of air switch mechanisms that involve other components and/or different manners of operation than the air switch mechanisms such as the air switch mechanism 120 described above. For example, in some embodiments, a power control module can have a normal state and an actuated state, and signals communicated by the air switch mechanism in response to user actuation of an actuator can cause the power control module to switch from the normal state to the actuated state and/or back again to the normal state. Also, the present disclosure is intended to encompass numerous different types of air switch mechanisms having any of a variety of types of actuators or actuation mechanisms.

It is specifically intended that the present invention not be limited to the embodiments and illustrations contained herein, but include modified forms of those embodiments including portions of the embodiments and combinations of elements of different embodiments as come within the scope of the following claims.

We claim:

1. A food waste disposer system comprising:
a housing including a bottom housing portion and a top housing portion;
a power control module supported at least partly within the housing;
a motor supported within the housing and coupled electrically, at least indirectly, to the power control module;
an actuator positioned externally of the housing;
an air conduction tube connecting the actuator at least indirectly with the power control module; and
a power link extending outward from the power control module and the housing, so that the power control module can be coupled electrically, at least indirectly, to a power source,
wherein the power control module is configured to switch between having a first operational status and having a second operational status in response to a pressure change communicated through the air conduction tube as a result of an actuation of the actuator, and
wherein electric power received at the power link from the power source is communicated to the motor from the power link at least indirectly via the power control module when the power control module has the first operational status, but is not communicated to the motor when the power control module has the second operational status.

2. The food waste disposer system of claim 1,
wherein the food waste disposer system includes a food waste disposer and an air switch assembly,
wherein the food waste disposer includes the housing and the motor,
wherein the air switch assembly includes the power link and an air switch mechanism, and
wherein the air switch mechanism includes the power control module, the air conduction tube, and the actuator.

3. The food waste disposer system of claim 2,
wherein the power control module additionally includes a base plate, a switching mechanism, and a terminal assembly,
wherein the switching mechanism and the terminal assembly are supported upon the base plate,
wherein the power link and air conduction tube are coupled to the switching mechanism and extend outward away from the switching mechanism through and outward away from the base plate.

4. The food waste disposer system of claim 3,
wherein the housing of the food waste disposer includes an orifice,
wherein the base plate is positioned along an exterior surface of the housing so as to substantially cover over the orifice, and
wherein the switching mechanism and the terminal assembly are substantially positioned within the orifice or within an interior of the food waste disposer when the base plate is positioned along the exterior surface so that the air switch assembly is fully coupled in relation to the food waste disposer.

5. The food waste disposer system of claim 4, wherein the base plate is secured in relation to the exterior surface of the housing by way of at least two securing features, wherein each of the at least two securing features is selected from the group consisting of a lip and a fastener.

6. The food waste disposer system of claim 5, wherein the base plate is secured along a bottom surface portion of the exterior surface of the housing.

7. The food waste disposer system of claim 4 wherein, when the air switch assembly is fully coupled in relation to the food waste disposer, the power control module is directly physically coupled to at least one internal component of the food waste disposer that is electrically coupled at least indirectly to the motor within the food waste disposer.

8. The food waste disposer system of claim 7,
wherein the at least one internal component of the food waste disposer includes a plurality of electrical contacts positioned proximate the orifice and coupled at least indirectly to the motor,
wherein the terminal assembly includes a plurality of electrical sockets, and
wherein the power control module is configured so that, when the air switch assembly is fully installed relative to the food waste disposer, the electrical contacts respectively are positioned within the electrical sockets, respectively, so as to complete an electrical connection between the power control module and the motor.

9. The food waste disposer system of claim 2, wherein the actuator is configured to be coupled to or mounted upon a sink.

10. The food waste disposer system of claim 1, wherein the actuator includes at least one of a pneumatic cylinder, a bladder, and a diaphragm structure.

11. The food waste disposer system of claim 1, wherein the power link is a power cord that includes a plug suitable for being coupled to a wall outlet.

12. The food waste disposer system of claim 11, wherein the plug is a NEMA-type plug.

13. The food waste disposer system of claim 1,
wherein the power control module includes a diaphragm structure and a switching mechanism including an electrical switch and a switch actuator by which the diaphragm structure and the electrical switch are at least indirectly in communication,
wherein the diaphragm structure is in fluid communication with the actuator by the air conduction tube and is configured to experience a movement in response to the pressure change, and
wherein the movement of the diaphragm structure can cause a switching of the electrical switch between first and second states corresponding respectively to the first and second operational statuses of the power control module.

14. The food waste disposer system of claim 13, wherein the electrical switch includes a single-throw switch.

15. The food waste disposer system of claim 1,
wherein the motor is selected from the group consisting of an inductive motor and a permanent magnet motor.

16. A method comprising:
providing a waste disposer system including
a housing including a bottom housing portion and a top housing portion,
a power control module supported at least partly within the housing,
a motor supported within the housing and coupled electrically, at least indirectly, to the power control module,
an actuator positioned externally of the housing,
an air conduction tube connecting the actuator at least indirectly with the power control module, and
a power link extending outward from the power control module and the housing, so that the power control module can be coupled electrically, at least indirectly, to a power source;
receiving electric power at the power control module at least indirectly via the power link;
transmitting a pressure change through the air conduction tube to the power control module in response to an actuation of the actuator; and
switching from a first operational status of the power control module to a second operational status of the power control module in response to the pressure change,
communicating the electric power received via the power link to the motor from the power link at least indirectly via the power control module when the power control module has the first operational status;
additionally switching from the second operational status to the first operational status in response to an additional pressure change; and
ceasing the communicating of the electric power to the motor when the power control module has the second operational status.

17. The method of claim 16, wherein the food waste disposer system includes a food waste disposer and an air switch assembly,
wherein the food waste disposer includes the housing and the motor,
wherein the air switch assembly includes the power link and an air switch mechanism,
wherein the air switch mechanism includes the power control module, the air conduction tube, and the actuator, and
wherein the providing of the waste disposer system includes installing the air switch assembly in relation to the food waste disposer so as to be integrated with the food waste disposer.

18. The method of claim 17, wherein the installing of the air switch assembly in relation to the food waste disposer includes each of
aligning a power control module of the air switch assembly relative to an orifice within the housing of the food waste disposer;
causing the power control module to proceed toward and at least partly into the orifice so that a switching mechanism and a terminal assembly of the power control module are inserted through the orifice and at least partly into an interior of the food waste disposer and so that a base plate of the power control module comes into contact with the housing;
sliding the base plate relative to the housing so that electrical sockets of the terminal assembly receive electrical contacts provided within the food waste disposer, the electrical contacts being electrically coupled to the motor; and
attaching the base plate relative to the housing.

19. An air switch assembly for implementation in combination with a waste disposer in an integrated manner so as to provide air switch control of operation of the waste disposer, the assembly comprising:
a power control module including a base plate and also a switching mechanism and a terminal assembly that are each supported upon the base plate,
wherein the base plate includes at least one feature that enables, at least in part, the base plate to be secured to the waste disposer;
a power link extending outward from the power control module,
wherein the power link includes a plug at an end apart from the power control module that is configured for being coupled to a wall outlet; and
an air switch mechanism including an actuator and an air conduction tube linking the actuator with the power control module,
wherein the switching mechanism includes a diaphragm structure at least indirectly in communication with an electrical switch, wherein the diaphragm structure is configured to be moved in response to pressure changes communicated via the air conduction tube in response to actuations of the actuator, and wherein the switching mechanism is configured so that the electrical switch changes switch states in response to movements of the diaphragm structure, and
wherein the terminal assembly includes a plurality of first electrical contacts that are configured to engage a plurality of second electrical contacts formed along an interior of the waste disposer, so as to allow for a direct physical connection and a direct electrical connection to be formed between the power control module and the plurality of second electrical contacts.

20. The air switch assembly of claim 19,
wherein the first electrical contacts are formed within electrical sockets of the terminal assembly that are configured to receive the second electrical contacts, wherein the plug is a NEMA-type plug, and wherein the electrical switch is a single throw switch, and
wherein the power control module is configured to have each of first and second operational statuses, wherein the first operational status occurs when the electrical switch has a closed state, and wherein the second operational status occurs when the electrical switch has an open state.
